(19) United States
(12) Patent Application Publication
(10) Pub. No.: US 2024/0064662 A1
(43) Pub. Date: Feb. 22, 2024

(54) AUTOMATIC GAIN CONTROL IN A FULL-DUPLEX NETWORK

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US); Qian ZHANG, Basking Ridge, NJ (US); Ahmed Omar Desouky ALI, Santa Clara, CA (US)

(21) Appl. No.: 18/318,412

(22) Filed: May 16, 2023

Related U.S. Application Data
(60) Provisional application No. 63/371,974, filed on Aug. 19, 2022.

(51) Int. Cl. H04W 52/52; H04L 5/14; H04L 5/00

(52) U.S. Cl. CPC H04W 52/52; H04L 5/14; H04L 5/0051

(57) ABSTRACT

Various aspects of the present disclosure generally relate to wireless communication. In some aspects, a user equipment (UE) may receive, from a network node associated with a full-duplex (FD) network, one or more tracking reference signals (TRSs) in a slot, wherein the slot is a half-duplex (HD) slot or an FD slot based at least in part on a slot type associated with the slot. The UE may calculate an automatic gain control (AGC) for the slot based at least in part on the one or more TRSs received in the slot and information regarding the slot type associated with the slot. Numerous other aspects are described.

### CROSS-REFERENCE TO RELATED APPLICATION

This Patent Application claims priority to U.S. Provisional Patent Application No. 63/371,974, filed on Aug. 19, 2022, entitled “AUTOMATIC GAIN CONTROL IN A FULL-DUPLEX NETWORK,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for automatic gain control (AGC) in a full-duplex (FD) network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full-duplex (FD) communications, in accordance with the present disclosure.

FIG. 5 is a diagram illustrating examples of FD communications, in accordance with the present disclosure.

FIG. 6 is a diagram illustrating an example of a sub-band full-duplex (SBFD) slot format, in accordance with the present disclosure.

FIG. 7 is a diagram illustrating examples of interference sources for a UE, in accordance with the present disclosure.

FIG. 8 is a diagram illustrating an example of impacts caused by a jamming power being larger than a power associated with a downlink received signal, in accordance with the present disclosure.

FIGS. 9-12 are diagrams illustrating examples associated with automatic gain control (AGC) in an FD network, in accordance with the present disclosure.

FIGS. 13-14 are diagrams illustrating example processes associated with AGC in an FD network, in accordance with the present disclosure.

FIG. 15 is a diagram of an example apparatus for wireless communication, in accordance with the present disclosure.

### SUMMARY

In some implementations, an apparatus for wireless communication at a user equipment (UE) includes a memory and one or more processors, coupled to the memory, configured to: receive, from a network node associated with a full-duplex (FD) network, one or more tracking reference signals (TRSs) in a slot, wherein the slot is a half-duplex (HD) slot or an FD slot based at least in part on a slot type associated with the slot; and calculate an automatic gain control (AGC) for the slot based at least in part on the one or more TRSs received in the slot and information regarding the slot type associated with the slot.

In some implementations, an apparatus for wireless communication at a UE includes a memory and one or more processors, coupled to the memory, configured to: receive, from a network node associated with an FD network, an indication of an AGC symbol at a boundary between an HD slot or symbol and an FD slot or symbol; and calculate an AGC using the AGC symbol based at least in part on a switching between the HD slot or symbol and the FD slot or symbol.

In some implementations, a method of wireless communication performed by a UE includes receiving, from a network node associated with an FD network, one or more TRSs in a slot, wherein the slot is an HD slot or an FD slot based at least in part on a slot type associated with the slot; and calculating an AGC for the slot based at least in part on the one or more TRSs received in the slot and information regarding the slot type associated with the slot.

In some implementations, a method of wireless communication performed by a UE includes receiving, from a network node associated with an FD network, an indication of an AGC symbol at a boundary between an HD slot or symbol and an FD slot or symbol; and calculating an AGC using the AGC symbol based at least in part on a switching between the HD slot or symbol and the FD slot or symbol.

In some implementations, a non-transitory computer-readable medium storing a set of instructions for wireless communication includes one or more instructions that, when executed by one or more processors of a UE, cause the UE to: receive, from a network node associated with an FD network, one or more TRSs in a slot, wherein the slot is an HD slot or an FD slot based at least in part on a slot type associated with the slot; and calculate an AGC for the slot based at least in part on the one or more TRSs received in the slot and information regarding the slot type associated with the slot.

In some implementations, a non-transitory computer-readable medium storing a set of instructions for wireless communication includes one or more instructions that, when executed by one or more processors of a UE, cause the UE to: receive, from a network node associated with an FD network, an indication of an AGC symbol at a boundary between an HD slot or symbol and an FD slot or symbol; and calculate an AGC using the AGC symbol based at least in part on a switching between the HD slot or symbol and the FD slot or symbol.

In some implementations, an apparatus for wireless communication includes means for receiving, from a network node associated with an FD network, one or more TRSs in a slot, wherein the slot is an HD slot or an FD slot based at least in part on a slot type associated with the slot; and means for calculating an AGC for the slot based at least in part on the one or more TRSs received in the slot and information regarding the slot type associated with the slot.

In some implementations, an apparatus for wireless communication includes means for receiving, from a network node associated with an FD network, an indication of an AGC symbol at a boundary between an HD slot or symbol and an FD slot or symbol; and means for calculating an AGC using the AGC symbol based at least in part on a switching between the HD slot or symbol and the FD slot or symbol.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

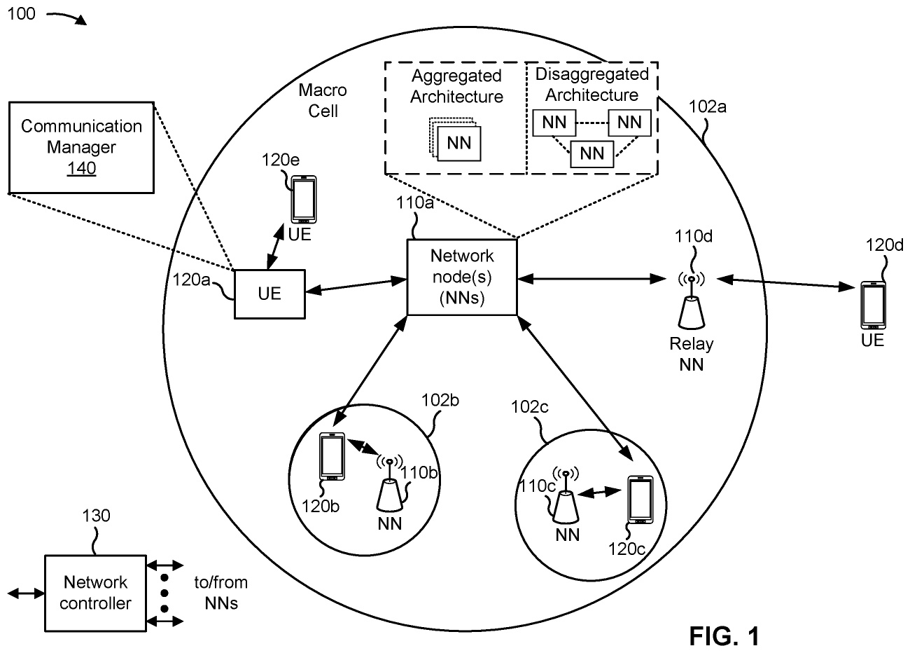

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node associated with a full-duplex (FD) network, one or more tracking reference signals (TRSs) in a slot, wherein the slot is a half-duplex (HD) slot or an FD slot based at least in part on a slot type associated with the slot; and calculate an automatic gain control (AGC) for the slot based at least in part on the one or more TRSs received in the slot and information regarding the slot type associated with the slot. As described in more detail elsewhere herein, the communication manager 140 may receive, from a network node associated with an FD network, an indication of an AGC symbol at a boundary between an HD slot or symbol and an FD slot or symbol; and calculate an AGC using the AGC symbol based at least in part on a switching between the HD slot or symbol and the FD slot or symbol. Additionally, or alternatively, the communication manager 140 may perform one or more other operations described herein.

As indicated above, FIG. 1 is provided as an example. Other examples may differ from what is described with regard to FIG. 1.

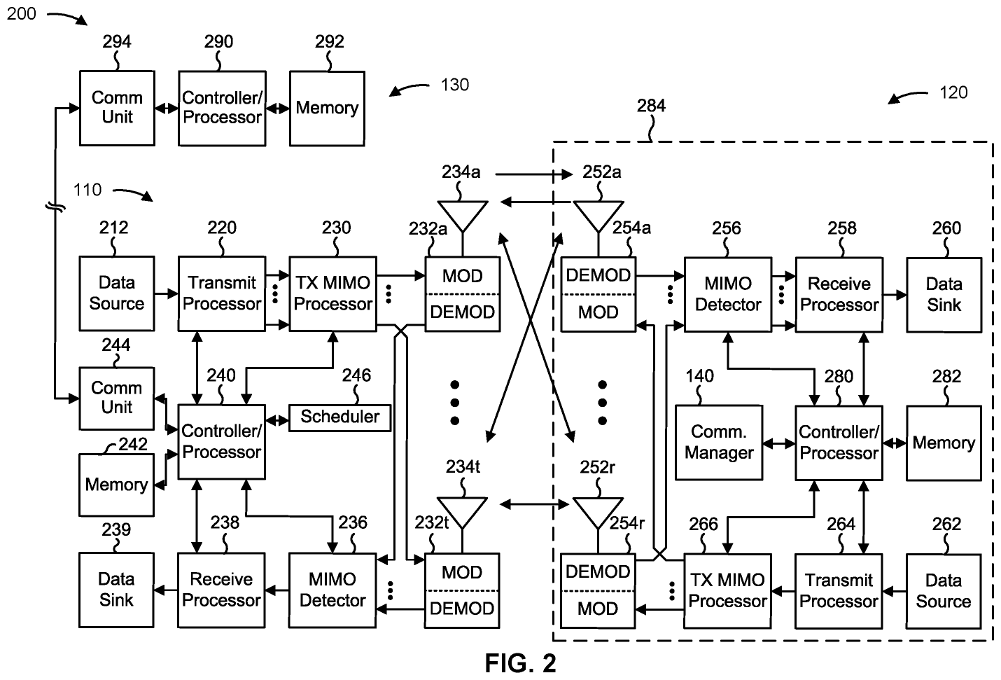

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

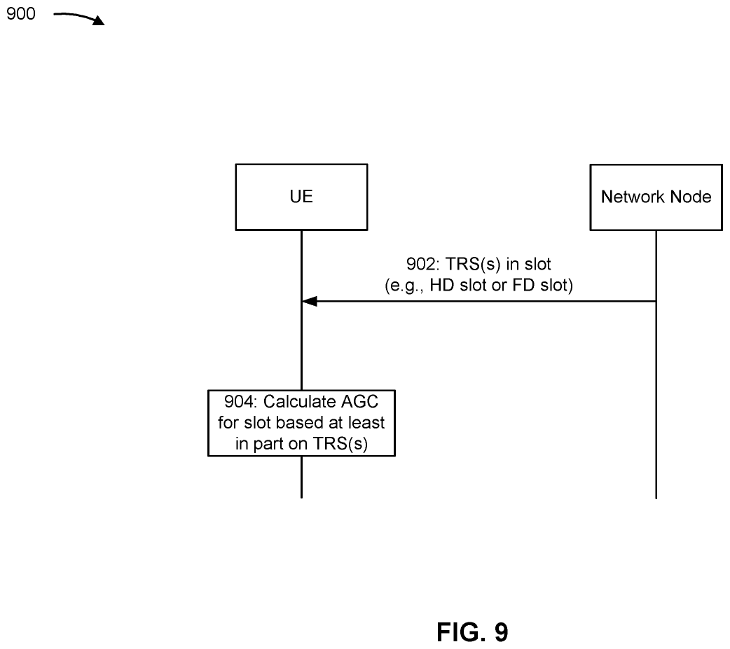

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9-15).

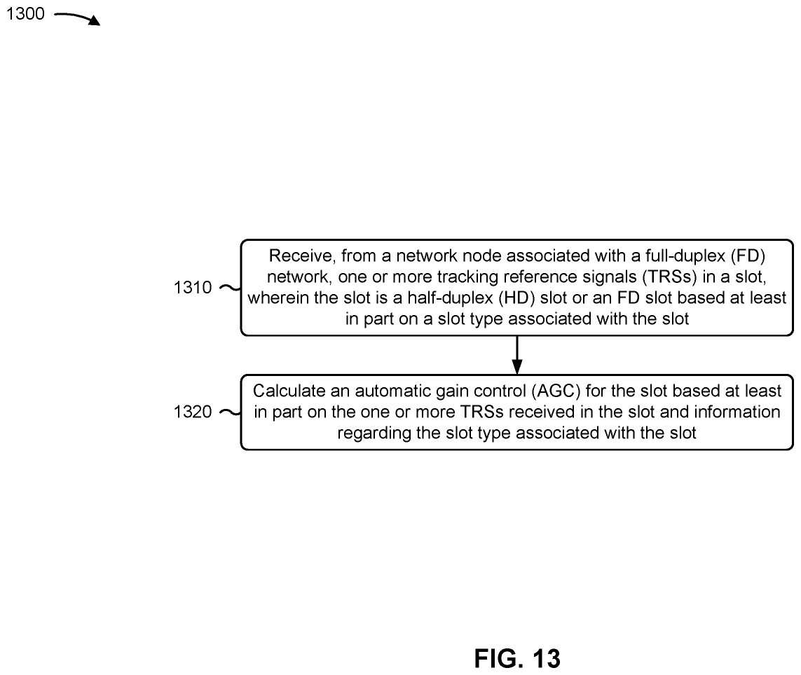

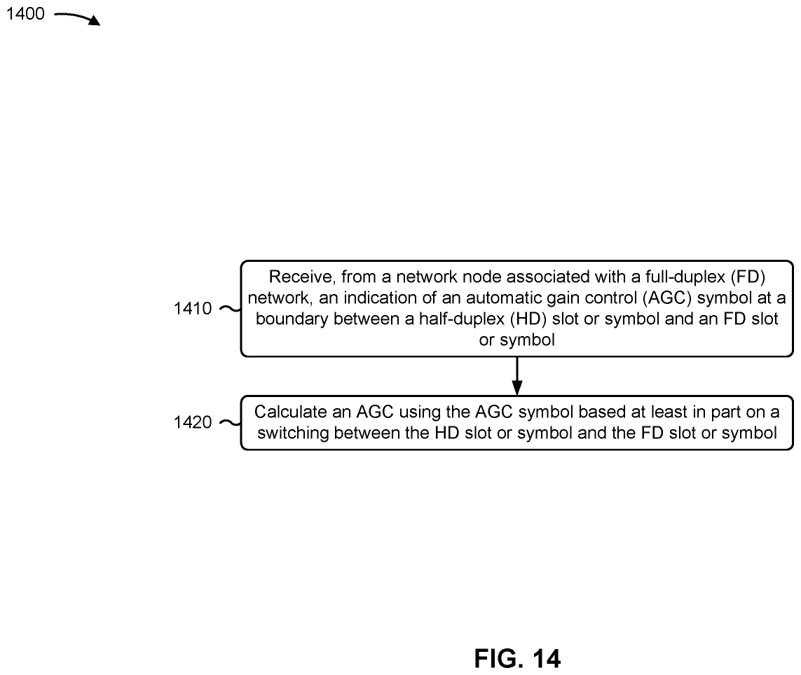

The controller/processor 240 of the network node 110, the controller/processor 280 of the UE 120, and/or any other component(s) of FIG. 2 may perform one or more techniques associated with AGC in an FD network, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network node associated with an FD network, one or more TRSs in a slot, wherein the slot is an HD slot or an FD slot based at least in part on a slot type associated with the slot; and/or means for calculating an AGC for the slot based at least in part on the one or more TRSs received in the slot and information regarding the slot type associated with the slot. In some aspects, the UE (e.g., UE 120) includes means for receiving, from a network node associated with an FD network, an indication of an AGC symbol at a boundary between an HD slot or symbol and an FD slot or symbol; and/or means for calculating an AGC using the AGC symbol based at least in part on a switching between the HD slot or symbol and the FD slot or symbol. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

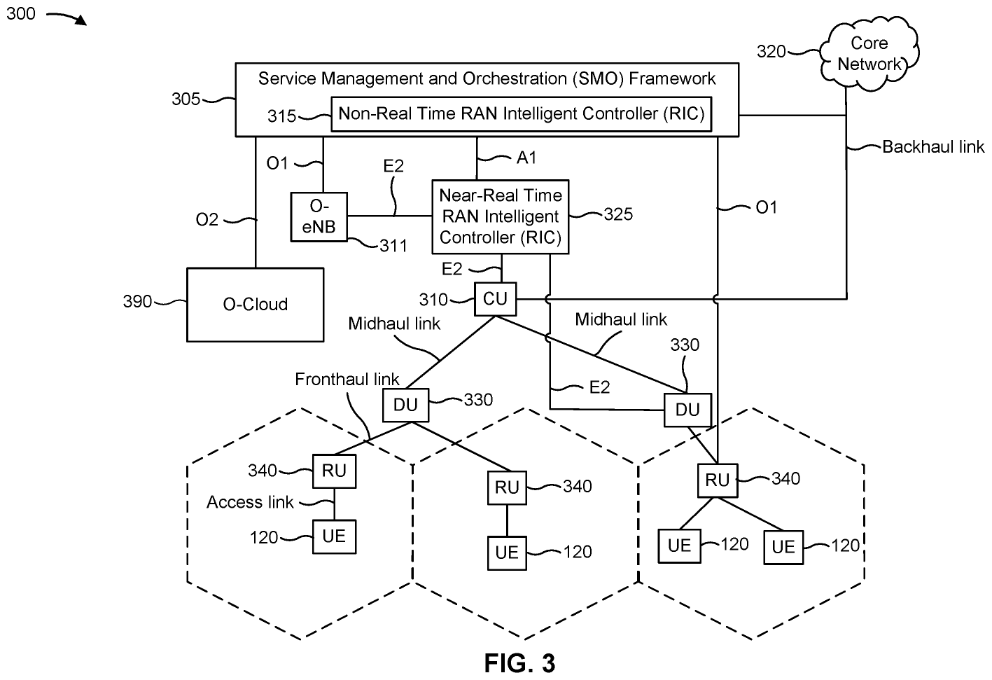

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

An FD operation may involve an in-band full-duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve a sub-band full duplex (SBFD) operation (or flexible duplex), in which a transmission and a reception may occur at the same time but on a different frequency resource. A downlink resource may be separated from an uplink resource in a frequency domain. In the SBFD operation, no downlink and uplink overlap in frequency may occur.

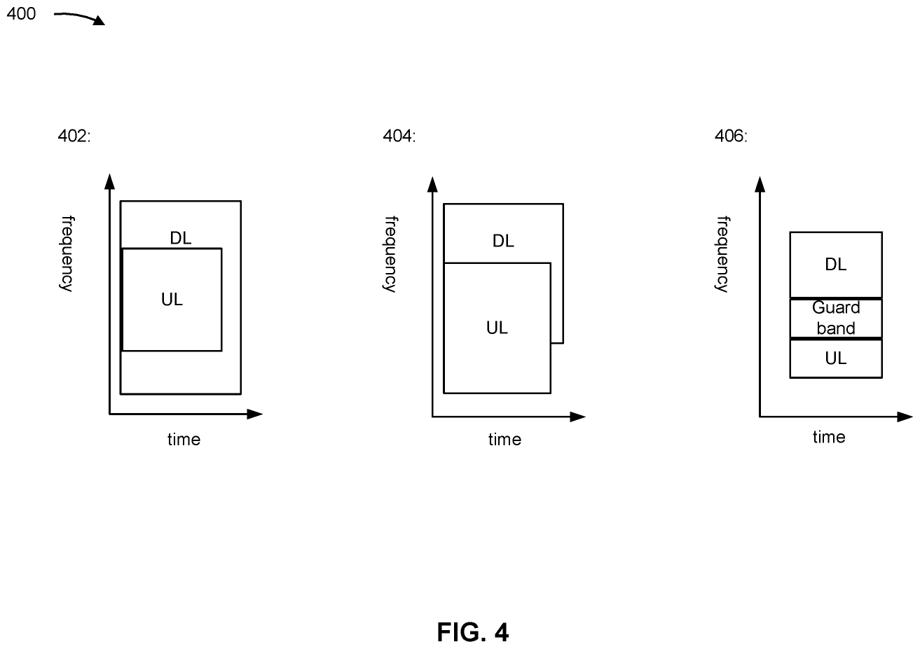

FIG. 4 is a diagram illustrating examples 400 of FD communications, in accordance with the present disclosure.

As shown by reference number 402, a downlink resource and an uplink resource may share the same IBFD time/frequency resource based at least in part on a full overlap. As shown by reference number 404, a downlink resource and an uplink resource may share the same IBFD time/frequency resource based at least in part on a partial overlap. As shown by reference number 406, a downlink resource and an uplink resource may be associated with a same time but different frequency. The downlink resource and the uplink resource may be separated by a guard band.

As indicated above, FIG. 4 is provided as an example. Other examples may differ from what is described with regard to FIG. 4.

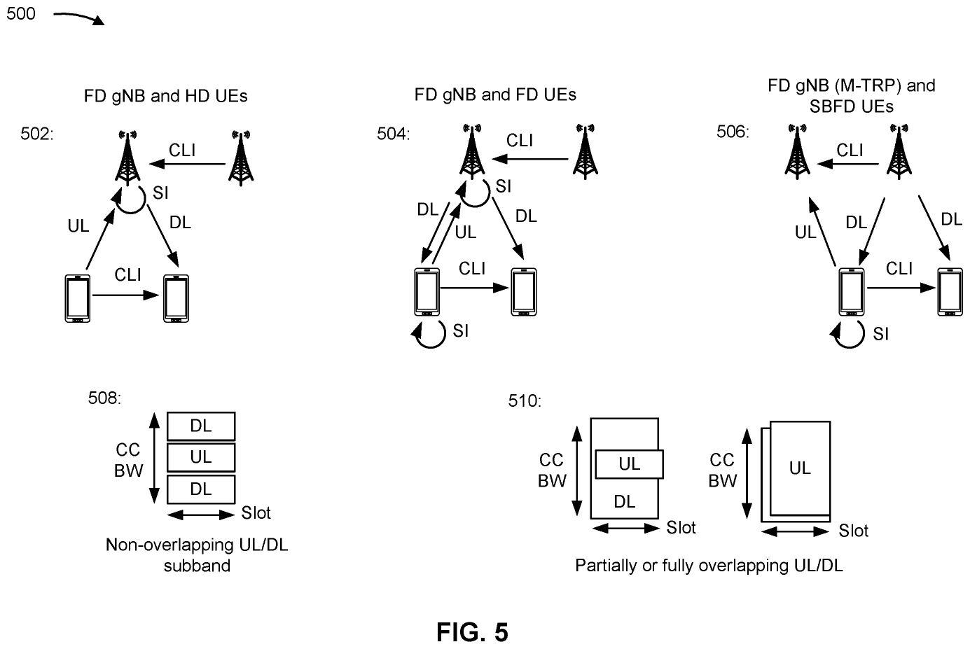

FIG. 5 is a diagram illustrating examples 500 of FD communications, in accordance with the present disclosure.

As shown by reference number 502, an FD network node may communicate with HD UEs. The FD network node may be subjected to cross-link interference (CLI) from another FD network node (e.g., inter-network node CLI). The FD network node may experience self-interference (SI). The FD network node may receive an uplink transmission from a first HD UE, and the FD network node may transmit a downlink transmission to a second HD UE. The second HD UE may be subjected to CLI from the first HD UE (e.g., inter-UE CLI), where the CLI may be based at least in part on the uplink transmission from the first HD UE.

As shown by reference number 504, an FD network node may communicate with FD UEs. The FD network node may be subjected to CLI from another FD network node. The FD network node may experience SI. The FD network node may transmit a downlink transmission to a first FD UE, and the FD network node may receive an uplink transmission from the first FD UE at the same time as the downlink transmission. The FD network node may transmit a downlink transmission to a second FD UE. The second HD UE may be subjected to CLI from the first HD UE, where the CLI may be based at least in part on the uplink transmission from the first FD UE. The first UE may experience SI.

As shown by reference number 506, a first FD network node, which may be associated with multiple TRPs, may communicate with SBFD UEs. The first FD network node may be subjected to CLI from a second FD network node. The first FD network node may receive an uplink transmission from a first SBFD UE. The second FD network node may transmit downlink transmissions to both the first SBFD UE and a second SBFD UE. The second SBFD UE may be subjected to CLI from the first SBFD UE, where the CLI may be based at least in part on the uplink transmission from the first SBFD UE. The first SBFD UE may experience SI.

As shown by reference number 508, an SBFD slot may be associated with a non-overlapping uplink/downlink sub-band. Within a component carrier bandwidth, an uplink resource may be in between, in a frequency domain, a first downlink resource and a second downlink resource. The first downlink resource, the second downlink resource, and the uplink resource may all be associated with the same time.

As shown by reference number 510, a slot may be associated with partially or fully overlapping uplink/downlink resources. Within a component carrier bandwidth, an uplink resource may fully or partially overlap with a downlink resource.

As indicated above, FIG. 5 is provided as an example. Other examples may differ from what is described with regard to FIG. 5.

An SBFD slot format may be a slot format that is defined as a “downlink and uplink” slot. The “downlink and uplink” slot may be a slot in which a band is used for both uplink and downlink transmissions. The downlink and uplink transmissions may occur in overlapping bands (e.g., IBFD) or in adjacent bands (e.g., SBFD). In a given “downlink and uplink” slot symbol, an HD UE may either transmit in an uplink band or receive in a downlink band. In a given “downlink and uplink” slot symbol, an FD UE may transmit in an uplink band and/or receive in a downlink band (e.g., in the same slot). The “downlink and uplink” slot may include downlink only symbols, uplink only symbols, or FD symbols.

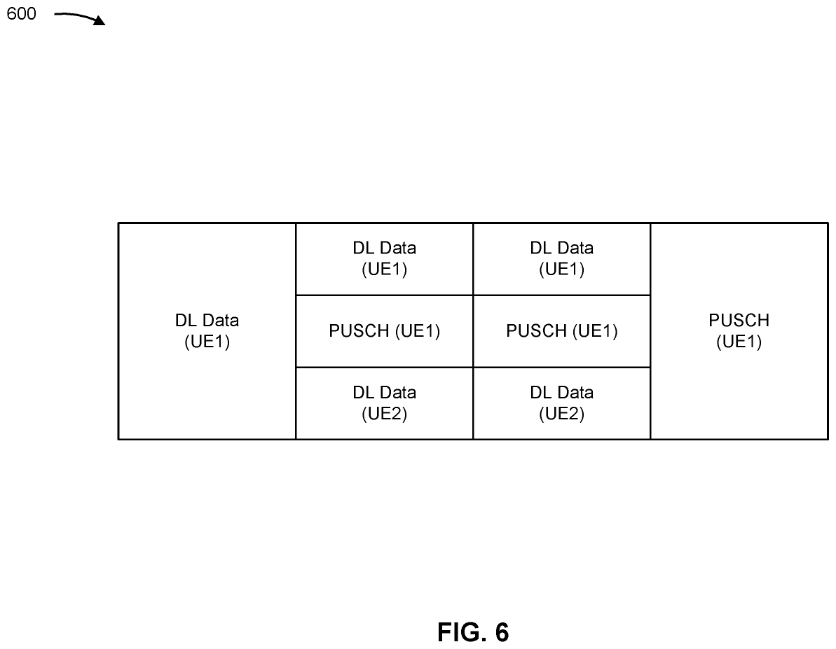

FIG. 6 is a diagram illustrating an example 600 of an SBFD slot format, in accordance with the present disclosure.

As shown in FIG. 6, a first slot may be associated with downlink data for a first UE. A second slot (e.g., an SBFD slot) may be associated with downlink data for the first UE, uplink data for the first UE, and downlink data for a second UE. The uplink data may be associated with a physical uplink shared channel (PUSCH) transmission. A third slot (e.g., an SBFD slot) may be associated with downlink data for the first UE, uplink data for the first UE, and downlink data for the second UE. A fourth slot may be associated with uplink data for the first UE.

As indicated above, FIG. 6 is provided as an example. Other examples may differ from what is described with regard to FIG. 6.

When a UE is operating in an HD mode and a network node is operating in an SBFD/IBFD mode, various sources of interference may be present for the UE. The UE may experience inter-cell experience from other network nodes. The UE may experience intra-cell CLI, which may be interference from UEs in the same cell. The UE may experience inter-cell CLI, which may be interference from UEs in adjacent cells. Further, when the UE is an FD UE, the UE may experience SI (e.g., a downlink transmission of the UE may cause interference to an uplink transmission associated with the UE, or vice versa).

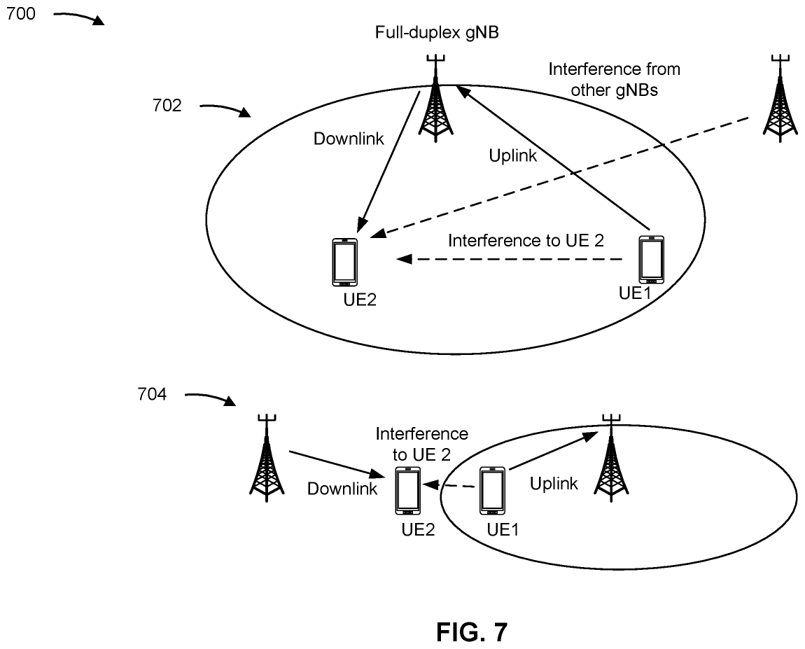

FIG. 7 is a diagram illustrating examples 700 of interference sources for a UE, in accordance with the present disclosure.

As shown by reference number 702, an FD network node may receive an uplink transmission from a first UE, and the FD network node may transmit a downlink transmission to a second UE. The second UE may experience interference from other network nodes, as well as from the first UE. In other words, the first UE may cause interference to the second UE.

As shown by reference number 704, a first network node may receive an uplink transmission from a first UE, and a second network node may transmit a downlink transmission to a second UE. The second UE may experience interference from the first UE. In other words, the first UE may cause interference to the second UE.

As indicated above, FIG. 7 is provided as an example. Other examples may differ from what is described with regard to FIG. 7.

Inter-UE CLI may have an effect on reference signal measurements. A UE may suffer from RF front end (RFEE) saturation or no RF saturation due to a jamming Tx signal of an aggressor UE (or multiple aggressor UEs) in an uplink sub-band. In the case of RFEE saturation, when a jamming power associated with the jamming Tx signal satisfies a threshold (e.g., a relatively large jamming power), a low noise amplifier (LNA) or RF receiver may be saturated, which may cause damage to RF components. In the case of no RF saturation, when the jamming power is larger than a power associated with a downlink reference signal received by the UE, a loss of dynamic range of an AGC may result. Further, when the jamming power is larger than the power associated with the downlink reference signal, a leakage (e.g., an out-of-band emission) of the jamming Tx signal may increase the interference at a downlink sub-band and reduce a signal to interference noise ratio (SINR) measured by the downlink reference signal.

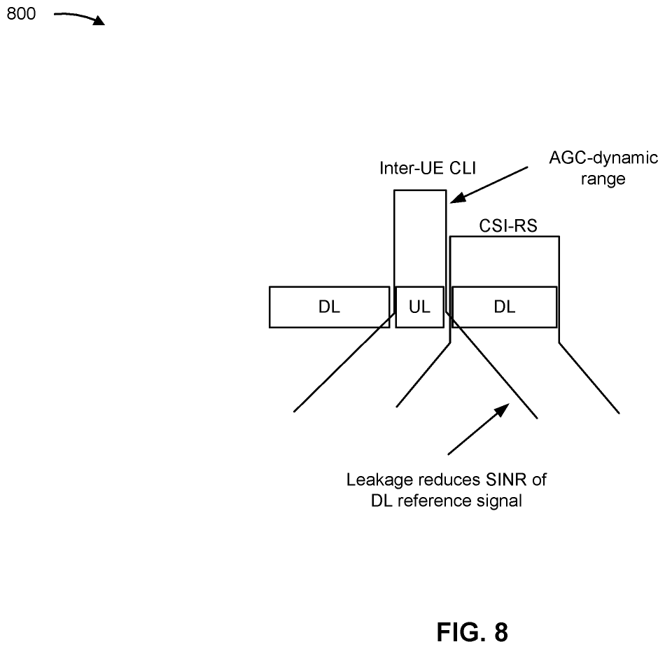

FIG. 8 is a diagram illustrating an example 800 of impacts caused by a jamming power being larger than a power associated with a downlink received signal, in accordance with the present disclosure.

As shown in FIG. 8, an uplink sub-band may be in between, in a frequency domain, a first downlink sub-band and a second downlink sub-band. The second downlink sub-band may be associated with a reception of a channel state information reference signal (CSI-RS). A jamming signal of an aggressor UE in the uplink sub-band may cause an inter-UE CLI. The inter-UE CLI may result in a loss of AGC dynamic range. Further, the inter-UE CLI may increase the interference at the second downlink sub-band, which may reduce an SINR measured by the CSI-RS.

As indicated above, FIG. 8 is provided as an example. Other examples may differ from what is described with regard to FIG. 8.

When a UE switches between an HD slot (e.g., a time division duplexing (TDD) slot that only includes downlink resources) and an FD slot (e.g., an SBFD slot that includes both downlink resources and uplink resources), an Rx AGC gain may be inaccurate due to an inter-UE CLI. For example, a synchronization signal block (SSB) SINR may drop due to a loss of dynamic range (e.g., an incorrect Rx AGC state gain). Rx AGC gain states may be based at least in part on a signal and interference received in physical downlink shared channel (PDSCH) data slots. The Rx AGC gain state may remain the same for a first slot associated with the SSB and a second slot associated with PDSCH data, even with a relatively large difference in an in-band RSSI for the first slot and the second slot. No uplink interference may be present in SSB slots.

In various aspects of techniques and apparatuses described herein, a UE may receive, from a network node, a TRS in a slot, where the slot may be an HD slot or an FD slot based at least in part on a slot type associated with the slot. The UE may calculate an AGC for the slot based at least in part on the TRS received in the slot, and based at least in part on information regarding the slot type (e.g., HD or FD) associated with the slot. Alternatively, the UE may receive, from the network node, an indication of an AGC symbol at a boundary between the HD slot and the FD slot. The UE may calculate the AGC using the AGC symbol based at least in part on a switching between the HD slot and the FD slot.

In some aspects, when switching between the HD slot (e.g., a TDD slot that only includes downlink resources) and the FD slot (e.g., an SBFD slot that includes both downlink resources and uplink resources), the UE may need to tune an Rx AGC gain based at least in part on a signal strength. For example, when switching from a downlink SBFD slot to a downlink SBFD slot, the Rx AGC gain may need to be retuned to an RSSI of a downlink signal. In some aspects, instead of having a guard period or symbol between the HD slot and the FD slot, the AGC symbol may be configured to aid the UE in adjusting the Rx AGC gain and performing a filter retuning. The filter retuning may be based at least in part on a UE filter change, which may improve a selectivity within SBFD symbols. Thus, the AGC symbol may be used for both adjusting the Rx AGC gain and for the filter retuning, which may improve a performance of the UE.

FIG. 9 is a diagram illustrating an example 900 associated with AGC in an FD network, in accordance with the present disclosure. As shown in FIG. 9, example 900 includes communication between a UE (e.g., UE 120) and a network node (e.g., network node 110). In some aspects, the UE and the network node may be included in a wireless network, such as wireless network 100.

As shown by reference number 902, the UE may receive, from the network node associated with an FD network, one or more TRSs in a slot. The slot may be an HD slot or an FD slot based at least in part on a slot type (e.g., HD slot type or FD slot type) associated with the slot. In some aspects, the one or more TRSs may include one TRS that is configured with two power offsets to a downlink shared channel, where a first power offset may be associated with the HD slot and a second power offset may be associated with the FD slot. In some aspects, the one or more TRSs may include two TRSs, where a first TRS of the two TRSs may be associated with an HD slot type and a second TRS of the two TRSs may be associated with an FD slot type.

As shown by reference number 904, the UE may calculate an AGC for the slot based at least in part on the one or more TRSs received in the slot, and based at least in part on information regarding the slot type associated with the slot. The UE may maintain two AGC states, where a first AGC state may be associated with the HD slot type and a second AGC state may be associated with the FD slot type. The UE may switch between the two AGC states at a slot boundary. In other words, a slot dependent AGC may be enabled based at least in part on the one or more TRSs received in the slot. Further, a filtering average and reset associated with an AGC calculation may occur based at least in part on a slot type change.

As indicated above, FIG. 9 is provided as an example. Other examples may differ from what is described with regard to FIG. 9.

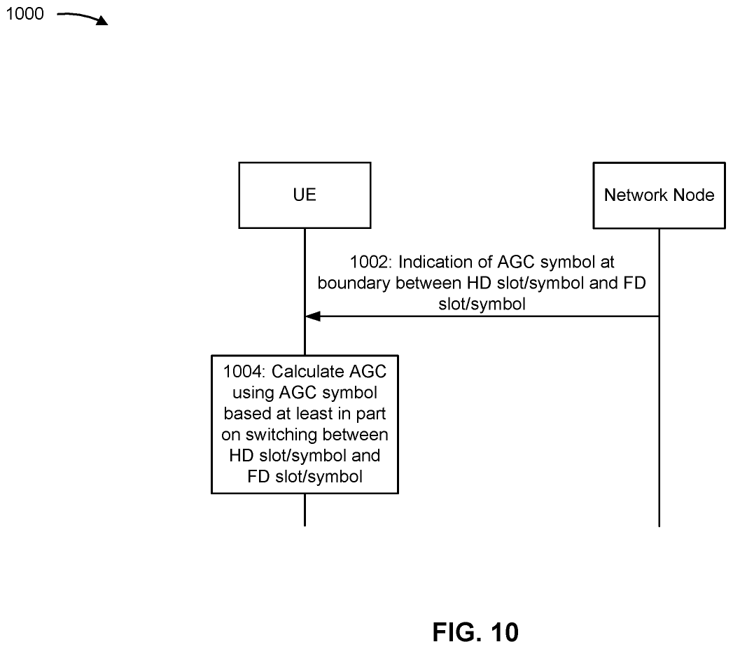

FIG. 10 is a diagram illustrating an example 1000 associated with AGC in an FD network, in accordance with the present disclosure. As shown in FIG. 10, example 1000 includes communication between a UE (e.g., UE 120) and a network node (e.g., network node 110). In some aspects, the UE and the network node may be included in a wireless network, such as wireless network 100.

As shown by reference number 1002, the UE may receive, from the network node associated with an FD network, an indication of an AGC symbol at a boundary between an HD slot/symbol and an FD slot/symbol. The AGC symbol may be associated with a sequence or a reference signal (e.g., a periodic reference signal or an aperiodic reference signal). The AGC symbol may be a duplicate of a first symbol in a slot. The indication of the AGC symbol may indicate that the AGC symbol is a downlink symbol for the UE.

In some aspects, the UE may receive the indication of the AGC symbol via a semi-static RRC configuration. The UE may receive the indication of the AGC symbol via a scheduling downlink control information (DCI). The UE may receive the indication of the AGC symbol via a configuration, which may be received by the UE via a medium access control control element (MAC-CE). The configuration may be activated or deactivated by the network node. In some aspects, the AGC symbol may be associated with an adaptation of a front-end AGC gain based at least in part on an RF detection of an in-band or channel jammer due to inter-UE CLI. The AGC gain may be adapted based at least in part on an energy associated with a detected signal from the RF detection satisfying a threshold.

In some aspects, a location of the AGC symbol in the slot may be a first symbol of the slot based at least in part on a downlink shared channel or a downlink control channel being transmitted in the slot. The location of the AGC symbol in the slot may be a last symbol of a previous slot based at least in part on the downlink shared channel or the downlink control channel being transmitted in the slot. The location of the AGC symbol in the slot may be based at least in part on an indication in a time domain resource allocation field (TDRA). The AGC symbol may be in a slot (e.g., an FD slot) that indicates an SSB, a TRS, a radio link monitoring reference signal (RLM-RS), or a radio resource monitoring reference signal (RRM-RS) and is preceded by a different type of slot (e.g., an HD slot). Further, the AGC symbol may be associated with a wideband across a whole bandwidth to enable a cross-link measurement in an uplink sub-band.

As shown by reference number 1004, the UE may calculate an AGC using the AGC symbol based at least in part on a switching between the HD slot/symbol and the FD slot/symbol. The UE may use the AGC symbol at the boundary between the HD slot/symbol and the FD slot/symbol to perform the AGC calculation. When the UE switches between the HD slot/symbol and the FD slot/symbol, the UE may tune an Rx AGC gain based at least in part on a signal strength, which may improve a performance of the UE.

As indicated above, FIG. 10 is provided as an example. Other examples may differ from what is described with regard to FIG. 10.

In some aspects, a UE may implement a slot dependent AGC. The UE may maintain two AGC states, where the UE may maintain one AGC state per each slot type. The UE may switch the AGC state at a slot boundary (e.g., a boundary between an HD slot and an FD slot). The UE may determine, for each slot, a slot type (e.g., an HD slot or an FD slot) associated with the slot, which may be based at least in part on a configuration received from a network node.

In some aspects, the network node may transmit a TRS in both HD and FD slots. The UE may use each TRS for a corresponding slot AGC calculation. For example, the UE may transmit a TRS for an HD slot. The UE may use the TRS associated with the HD slot to perform an AGC calculation for the HD slot. The UE may transmit a TRS for an FD slot. The UE may use the TRS associated with the FD slot to perform an AGC calculation for the FD slot. The UE may separately use the TRS associated with the HD slot and the TRS associated with the FD slot to perform corresponding slot AGC calculations.

In some aspects, a TRS may be configured with two power offsets to a PDSCH. A first power offset may be for HD slots. A second power offset may be for FD slots. One TRS may be transmitted with two different power offsets. In some aspects, two TRSs may be configured, where one TRS may be for each slot type. Two TRSs may be transmitted for each slot type. In other words, a first TRS may be for HD slots and a second TRS may be for FD slots. In some aspects, a filtering average and reset may be performed each time a slot type changes (e.g., a change from an HD slot to an FD slot).

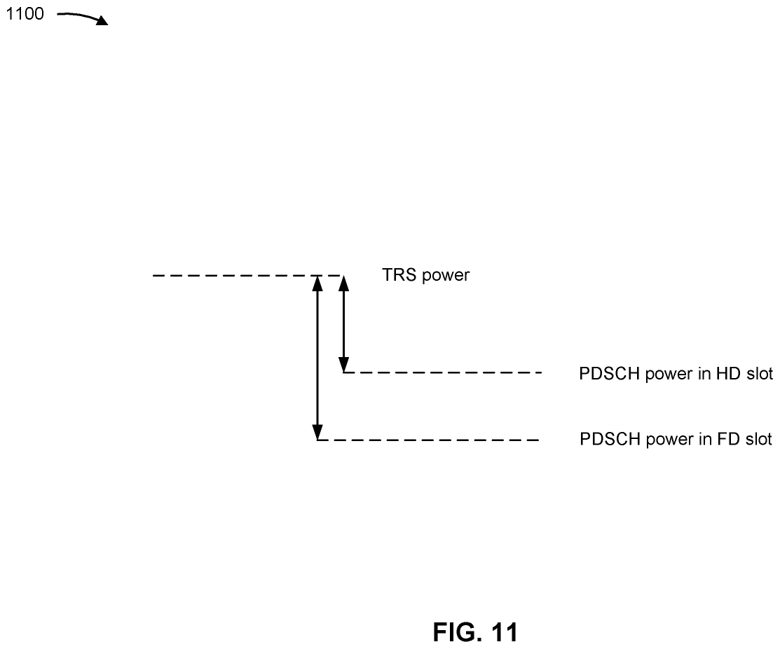

FIG. 11 is a diagram illustrating an example 1100 associated with AGC in an FD network, in accordance with the present disclosure.

As shown in FIG. 11, a TRS power may be configured with two power offsets to a PDSCH. A first power offset may be associated with a PDSCH power in an HD slot. A second power offset may be associated with a PDSCH power in an FD slot. In other words, rather than configuring a single power offset to the PDSCH, two separate power offsets may be defined. The two separate power offsets may include a first power offset for the HD slot and a second power offset for the FD slot.

As indicated above, FIG. 11 is provided as an example. Other examples may differ from what is described with regard to FIG. 10.

In some aspects, a UE may employ a single AGC calculation with a fast/dynamic adaptation between slot types. The UE may set an AGC (e.g., an Rx AGC gain) when switching between HD symbols (e.g., TDD symbols) and FD symbols (e.g., SBFD symbols) based at least in part on an AGC symbol that exists at a boundary/switching between slots/symbols. The AGC symbol may be at an end of an HD slot, or the AGC symbol may be at a beginning of an FD slot, where the UE may use the AGC symbol to readjust its AGC calculation. The AGC symbol may be associated with certain content, such as a special sequence, a reference signal, or a duplicate of a first symbol. In some aspects, an indication of the AGC symbol may be configured via RRC signaling (e.g., semi-statically). For example, the indication may indicate that the AGC symbol is one of a first few symbol(s) of a switched slot. The indication of the AGC symbol may be indicated by a scheduling DCI. A configuration of the AGC symbol may be indicated by a MAC-CE and may be activated/deactivated. The AGC symbol may be indicated as a downlink symbol for the UE. The AGC symbol may not be indicated as an uplink signal because the AGC symbol may be used for a tuning of a downlink. The AGC symbol may be associated with the reference signal, where the reference signal may be configured as a periodic reference signal or an aperiodic reference signal.

In some aspects, the UE may utilize configured AGC symbols for a fast adaptation of a front-end AGC gain state, which may be associated with an LNA. The UE may utilize the configured AGC symbols for the fast adaptation of a front-end AGC gain state based at least in part on an RF detection of an in-band/channel jammer due to inter-UE CLI. The UE may include an RF circuit, which may measure an energy of a signal plus interference during an AGC symbol (e.g., a configured AGC resource). The UE may adapt an LNA gain based at least in part on the energy of the signal plus interference satisfying a threshold (e.g., the energy of the signal plus interference exceeds the threshold). In other words, the UE may perform the RF detection of the in-band/channel jammer due to inter-UE CLI during the configured AGC symbol, and the UE may adjust an AGC gain depending on the RF detection. As a result, a faster adaption of the AGC gain may be enabled, in addition to a proper protection of a downlink signal.

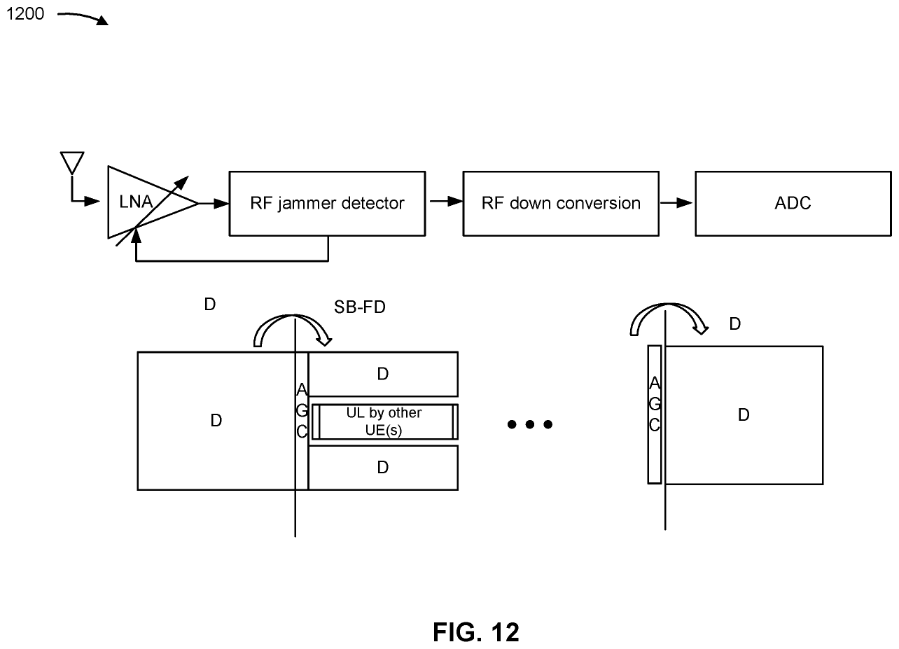

FIG. 12 is a diagram illustrating an example 1200 associated with AGC in an FD network, in accordance with the present disclosure.

As shown in FIG. 12, a receiver (e.g., a UE) may receive a signal, which may be provided to an LNA of the receiver. The receiver may include an RF jammer detector (or RF circuit) to perform an RF detection. During the RF detection, the receiver may measure an energy of the signal plus interference. The receiver may perform a processing of the signal, which may involve an RF down conversion and an analog-to-digital conversion (ADC). During the RF detection, the receiver may determine whether in-band/channel jamming (or interference) is present due to inter-UE CLI. When the receiver detects a presence of in-band/channel jamming due to inter-UE CLI, the receiver may use configured AGC resources to adjust an AGC gain. When the receiver does not detect the presence of in-band/channel jamming due to inter-UE CLI, the receiver may follow an HD AGC gain (or TDD AGC gain).

As indicated above, FIG. 12 is provided as an example. Other examples may differ from what is described with regard to FIG. 12.

In some aspects, a location of an AGC symbol (or multiple AGC symbols) may be defined. In a first option, when a PDSCH or physical downlink control channel (PDCCH) is transmitted in a slot, the AGC symbol may be a first symbol of the slot (e.g., a K0>0 DCI received in an earlier slot, where K0 is an offset between a downlink slot in which a PDCCH (DCI) for downlink scheduling is received and a downlink slot in which PDSCH data is scheduled). In a second option, when the PDSCH/PDCCH is transmitted in the slot, the AGC symbol may be the last symbol of the previous slot. In a third option, a TDRA field may provide an indication regarding a location of the AGC symbol. In some aspects, when a slot (e.g., an FD slot or SBFD slot) includes an SSB, a TRS, an RLM-RS, or an RRM-RS preceded by a different type of slot (e.g., an HD slot or TDD slot), the slot may include the AGC symbol (e.g., the slot may always include the AGC symbol). In some aspects, the UE may assume that the AGC symbol (e.g., a reference signal associated with the AGC symbol) is wideband across a whole bandwidth, which may enable an accurate CLI measurement in an uplink sub-band. For a repetition of a DMRS, the UE may assume that the DMRS is wideband across two sub-bands.

FIG. 13 is a diagram illustrating an example process 1300 performed, for example, by a UE, in accordance with the present disclosure. Example process 1300 is an example where the UE (e.g., UE 120) performs operations associated with AGC in an FD network.

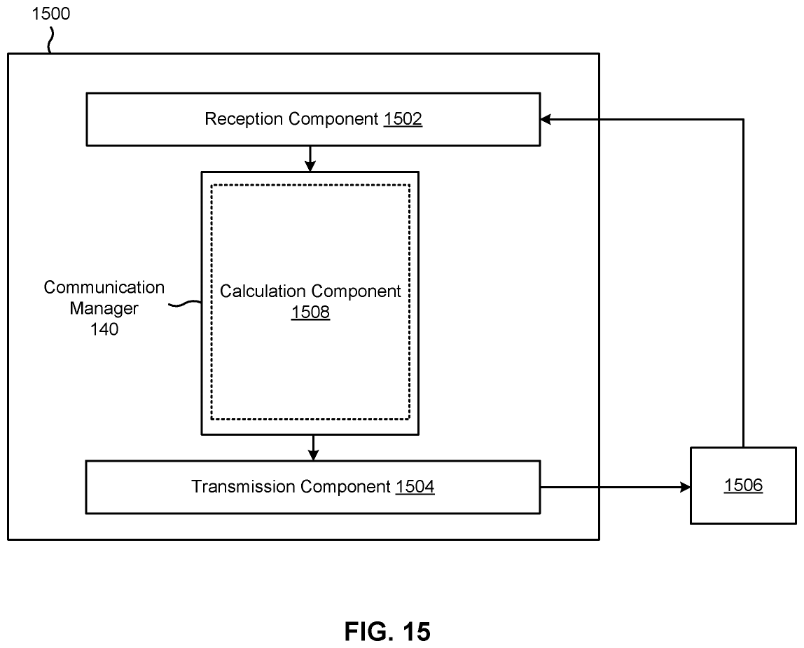

As shown in FIG. 13, in some aspects, process 1300 may include receiving, from a network node associated with an FD network, one or more TRSs in a slot, wherein the slot is an HD slot or an FD slot based at least in part on a slot type associated with the slot (block 1310). For example, the UE (e.g., using communication manager 140 and/or reception component 1502, depicted in FIG. 15) may receive, from a network node associated with an FD network, one or more TRSs in a slot, wherein the slot is an HD slot or an FD slot based at least in part on a slot type associated with the slot, as described in connection with FIGS. 9-12.

As further shown in FIG. 13, in some aspects, process 1300 may include calculating an AGC for the slot based at least in part on the one or more TRSs received in the slot and information regarding the slot type associated with the slot (block 1320). For example, the UE (e.g., using communication manager 140 and/or calculation component 1508 depicted in FIG. 15) may calculate an AGC for the slot based at least in part on the one or more TRSs received in the slot and information regarding the slot type associated with the slot, as described in connection with FIGS. 9-12.

Process 1300 may include additional aspects, such as any single aspect or any combination of aspects described below and/or in connection with one or more other processes described elsewhere herein.

In a first aspect, the UE maintains two AGC states, where a first AGC state is associated with an HD slot type and a second AGC state is associated with an FD slot type, and the UE is configured to switch between the two AGC states at a slot boundary.

In a second aspect, alone or in combination with the first aspect, a slot dependent AGC is enabled based at least in part on the one or more TRSs received in the slot.

In a third aspect, alone or in combination with one or more of the first and second aspects, the one or more TRSs include one TRS that is configured with two power offsets to a downlink shared channel, wherein a first power offset is associated with the HD slot and a second power offset is associated with the FD slot.

In a fourth aspect, alone or in combination with one or more of the first through third aspects, the one or more TRSs include two TRSs, wherein a first TRS of the two TRSs is associated with an HD slot type and a second TRS of the two TRSs is associated with an FD slot type.

In a fifth aspect, alone or in combination with one or more of the first through fourth aspects, a filtering average and reset associated with an AGC calculation occurs based at least in part on a slot type change.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120) performs operations associated with AGC in an FD network.

As shown in FIG. 14, in some aspects, process 1400 may include receiving, from a network node associated with an FD network, an indication of an AGC symbol at a boundary between an HD slot or symbol and an FD slot or symbol (block 1410). For example, the UE (e.g., using communication manager 140 and/or reception component 1502, depicted in FIG. 15) may receive, from a network node associated with an FD network, an indication of an AGC symbol at a boundary between an HD slot or symbol and an FD slot or symbol, as described in connection with FIGS. 9-12.

As further shown in FIG. 14, in some aspects, process 1400 may include calculating an AGC using the AGC symbol based at least in part on a switching between the HD slot or symbol and the FD slot or symbol (block 1420). For example, the UE (e.g., using communication manager 140 and/or calculation component 1508, depicted in FIG. 15) may calculate an AGC using the AGC symbol based at least in part on a switching between the HD slot or symbol and the FD slot or symbol, as described in connection with FIGS. 9-12.

Process 1400 may include additional aspects, such as any single aspect or any combination of aspects described below and/or in connection with one or more other processes described elsewhere herein.

In a first aspect, the AGC symbol is associated with a sequence or a reference signal, or wherein the AGC symbol is a duplicate of a first symbol in a slot.

In a second aspect, alone or in combination with the first aspect, the indication of the AGC symbol is received via a semi-static RRC configuration.

In a third aspect, alone or in combination with one or more of the first and second aspects, the indication of the AGC symbol is received via a scheduling DCI.

In a fourth aspect, alone or in combination with one or more of the first through third aspects, the indication of the AGC symbol is associated with a configuration of the AGC symbol that is received via a MAC-CE, and the configuration is activated or deactivated by the network node.

In a fifth aspect, alone or in combination with one or more of the first through fourth aspects, the indication of the AGC symbol indicates the AGC symbol as a downlink symbol for the UE.

In a sixth aspect, alone or in combination with one or more of the first through fifth aspects, the AGC symbol is associated with a periodic reference signal or an aperiodic reference signal.

In a seventh aspect, alone or in combination with one or more of the first through sixth aspects, the AGC symbol is associated with an adaptation of a front-end AGC gain based at least in part on an RF detection of an in-band or channel jammer due to inter-UE cross-link interference, and the AGC gain is adapted based at least in part on an energy associated with a detected signal from the RF detection satisfying a threshold.

In an eighth aspect, alone or in combination with one or more of the first through seventh aspects, a location of the AGC symbol in a slot is a first symbol of the slot based at least in part on a downlink shared channel or a downlink control channel being transmitted in the slot.

In a ninth aspect, alone or in combination with one or more of the first through eighth aspects, a location of the AGC symbol in a slot is a location of a last symbol of a previous slot based at least in part on a downlink shared channel or a downlink control channel being transmitted in the slot.

In a tenth aspect, alone or in combination with one or more of the first through ninth aspects, a location of the AGC symbol in a slot is based at least in part on an indication in a TDRA field.

In an eleventh aspect, alone or in combination with one or more of the first through tenth aspects, the AGC symbol is in a slot that indicates an SSB, a TRS, an RLM-RS, or an RRM-RS and is preceded by a different type of slot, wherein the slot is the FD slot and the different type of slot is the HD slot.

In a twelfth aspect, alone or in combination with one or more of the first through eleventh aspects, the AGC symbol is associated with a wideband across a whole bandwidth to enable a cross-link measurement in an uplink sub-band.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include a calculation component 1508, among other examples.

In some aspects, the apparatus 1500 may be configured to perform one or more operations described herein in connection with FIGS. 9-12. Additionally, or alternatively, the apparatus 1500 may be configured to perform one or more processes described herein, such as process 1300 of FIG. 13, process 1400 of FIG. 14, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 may receive, from a network node associated with an FD network, one or more TRSs in a slot, wherein the slot is an HD slot or an FD slot based at least in part on a slot type associated with the slot. The calculation component 1508 may calculate an AGC for the slot based at least in part on the one or more TRSs received in the slot and information regarding the slot type associated with the slot.

The reception component 1502 may receive, from a network node associated with an FD network, an indication of an AGC symbol at a boundary between an HD slot or symbol and an FD slot or symbol. The calculation component 1508 may calculate an AGC using the AGC symbol based at least in part on a switching between the HD slot or symbol and the FD slot or symbol.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving, from a network node associated with a full-duplex (FD) network, one or more tracking reference signals (TRSs) in a slot, wherein the slot is a half-duplex (HD) slot or an FD slot based at least in part on a slot type associated with the slot; and calculating an automatic gain control (AGC) for the slot based at least in part on the one or more TRSs received in the slot and information regarding the slot type associated with the slot.

Aspect 2: The method of Aspect 1, wherein the UE maintains two AGC states, where a first AGC state is associated with an HD slot type and a second AGC state is associated with an FD slot type, and wherein the UE is configured to switch between the two AGC states at a slot boundary.

Aspect 3: The method of any of Aspects 1 through 2, wherein a slot dependent AGC is enabled based at least in part on the one or more TRSs received in the slot.

Aspect 4: The method of any of Aspects 1 through 3, wherein the one or more TRSs include one TRS that is configured with two power offsets to a downlink shared channel, wherein a first power offset is associated with the HD slot and a second power offset is associated with the FD slot.

Aspect 5: The method of any of Aspects 1 through 4, wherein the one or more TRSs include two TRSs, wherein a first TRS of the two TRSs is associated with an HD slot type and a second TRS of the two TRSs is associated with an FD slot type.

Aspect 6: The method of any of Aspects 1 through 5, wherein a filtering average and reset associated with an AGC calculation occurs based at least in part on a slot type change.

Aspect 7: A method of wireless communication performed by a user equipment (UE), comprising: receiving, from a network node associated with a full-duplex (FD) network, an indication of an automatic gain control (AGC) symbol at a boundary between a half-duplex (HD) slot or symbol and an FD slot or symbol; and calculating an AGC using the AGC symbol based at least in part on a switching between the HD slot or symbol and the FD slot or symbol.

Aspect 8: The method of Aspect 7, wherein the AGC symbol is associated with a sequence or a reference signal, or wherein the AGC symbol is a duplicate of a first symbol in a slot.

Aspect 9: The method of any of Aspects 7 through 8, wherein the indication of the AGC symbol is received via a semi-static radio resource control configuration.

Aspect 10: The method of any of Aspects 7 through 9, wherein the indication of the AGC symbol is received via a scheduling downlink control information.

Aspect 11: The method of any of Aspects 7 through 10, wherein the indication of the AGC symbol is associated with a configuration of the AGC symbol that is received via a medium access control control element, and wherein the configuration is activated or deactivated by the network node.

Aspect 12: The method of any of Aspects 7 through 11, wherein the indication of the AGC symbol indicates the AGC symbol as a downlink symbol for the UE.

Aspect 13: The method of any of Aspects 7 through 12, wherein the AGC symbol is associated with a periodic reference signal or an aperiodic reference signal.

Aspect 14: The method of any of Aspects 7 through 13, wherein the AGC symbol is associated with an adaptation of a front-end AGC gain based at least in part on a radio frequency (RF) detection of an in-band or channel jammer due to inter-UE cross-link interference, and wherein the AGC gain is adapted based at least in part on an energy associated with a detected signal from the RF detection satisfying a threshold.

Aspect 15: The method of any of Aspects 7 through 14, wherein a location of the AGC symbol in a slot is a first symbol of the slot based at least in part on a downlink shared channel or a downlink control channel being transmitted in the slot.

Aspect 16: The method of any of Aspects 7 through 15, wherein a location of the AGC symbol in a slot is a location of a last symbol of a previous slot based at least in part on a downlink shared channel or a downlink control channel being transmitted in the slot.

Aspect 17: The method of any of Aspects 7 through 16, wherein a location of the AGC symbol in a slot is based at least in part on an indication in a time domain resource allocation field.

Aspect 18: The method of any of Aspects 7 through 17, wherein the AGC symbol is in a slot that indicates a synchronization signal block, a tracking reference signal, a radio link monitoring reference signal, or a radio resource monitoring reference signal and is preceded by a different type of slot, wherein the slot is the FD slot and the different type of slot is the HD slot.

Aspect 19: The method of any of Aspects 7 through 18, wherein the AGC symbol is associated with a wideband across a whole bandwidth to enable a cross-link measurement in an uplink sub-band.

Aspect 20: An apparatus for wireless communication at a device, comprising a processor; memory coupled with the processor; and instructions stored in the memory and executable by the processor to cause the apparatus to perform the method of one or more of Aspects 1-19.

Aspect 21: A device for wireless communication, comprising a memory and one or more processors coupled to the memory, the one or more processors configured to perform the method of one or more of Aspects 1-19.

Aspect 22: An apparatus for wireless communication, comprising at least one means for performing the method of one or more of Aspects 1-19.

Aspect 23: A non-transitory computer-readable medium storing code for wireless communication, the code comprising instructions executable by a processor to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network node associated with a full-duplex (FD) network, one or more tracking reference signals (TRSs) in a slot, wherein the slot is a half-duplex (HD) slot or an FD slot based at least in part on a slot type associated with the slot; and
calculate an automatic gain control (AGC) for the slot based at least in part on the one or more TRSs received in the slot and information regarding the slot type associated with the slot.

2. The apparatus of claim 1, wherein the UE maintains two AGC states, where a first AGC state is associated with an HD slot type and a second AGC state is associated with an FD slot type, and wherein the UE is configured to switch between the two AGC states at a slot boundary.

3. The apparatus of claim 1, wherein a slot dependent AGC is enabled based at least in part on the one or more TRSs received in the slot.

4. The apparatus of claim 1, wherein the one or more TRSs include one TRS that is configured with two power offsets to a downlink shared channel, wherein a first power offset is associated with the HD slot and a second power offset is associated with the FD slot.

5. The apparatus of claim 1, wherein the one or more TRSs include two TRSs, wherein a first TRS of the two TRSs is associated with an HD slot type and a second TRS of the two TRSs is associated with an FD slot type.

6. The apparatus of claim 1, wherein a filtering average and reset associated with an AGC calculation occurs based at least in part on a slot type change.

7. An apparatus for wireless communication at a user equipment (UE), comprising:
a memory; and
one or more processors, coupled to the memory, configured to:
receive, from a network node associated with a full-duplex (FD) network, an indication of an automatic gain control (AGC) symbol at a boundary between a half-duplex (HD) slot or symbol and an FD slot or symbol; and
calculate an AGC using the AGC symbol based at least in part on a switching between the HD slot or symbol and the FD slot or symbol.

8. The apparatus of claim 7, wherein the AGC symbol is associated with a sequence or a reference signal, or wherein the AGC symbol is a duplicate of a first symbol in a slot.

9. The apparatus of claim 7, wherein the indication of the AGC symbol is received via a semi-static radio resource control configuration.

10. The apparatus of claim 7, wherein the indication of the AGC symbol is received via a scheduling downlink control information.

11. The apparatus of claim 7, wherein the indication of the AGC symbol is associated with a configuration of the AGC symbol that is received via a medium access control control element, and wherein the configuration is activated or deactivated by the network node.

12. The apparatus of claim 7, wherein the indication of the AGC symbol indicates the AGC symbol as a downlink symbol for the UE.

13. The apparatus of claim 7, wherein the AGC symbol is associated with a periodic reference signal or an aperiodic reference signal.

14. The apparatus of claim 7, wherein the AGC symbol is associated with an adaptation of a front-end AGC gain based at least in part on a radio frequency (RF) detection of an in-band or channel jammer due to inter-UE cross-link interference, and wherein the AGC gain is adapted based at least in part on an energy associated with a detected signal from the RF detection satisfying a threshold.

15. The apparatus of claim 7, wherein a location of the AGC symbol in a slot is a first symbol of the slot based at least in part on a downlink shared channel or a downlink control channel being transmitted in the slot.

16. The apparatus of claim 7, wherein a location of the AGC symbol in a slot is a location of a last symbol of a previous slot based at least in part on a downlink shared channel or a downlink control channel being transmitted in the slot.

17. The apparatus of claim 7, wherein a location of the AGC symbol in a slot is based at least in part on an indication in a time domain resource allocation field.

18. The apparatus of claim 7, wherein the AGC symbol is in a slot that indicates a synchronization signal block, a tracking reference signal, a radio link monitoring reference signal, or a radio resource monitoring reference signal and is preceded by a different type of slot, wherein the slot is the FD slot and the different type of slot is the HD slot.

19. The apparatus of claim 7, wherein the AGC symbol is associated with a wideband across a whole bandwidth to enable a cross-link measurement in an uplink sub-band.

20. A method of wireless communication performed by a user equipment (UE), comprising:
receiving, from a network node associated with a full-duplex (FD) network, one or more tracking reference signals (TRSs) in a slot, wherein the slot is a half-duplex (HD) slot or an FD slot based at least in part on a slot type associated with the slot; and
calculating an automatic gain control (AGC) for the slot based at least in part on the one or more TRSs received in the slot and information regarding the slot type associated with the slot.

21. The method of claim 20, wherein the UE maintains two AGC states, where a first AGC state is associated with an HD slot type and a second AGC state is associated with an FD slot type, and wherein the UE is configured to switch between the two AGC states at a slot boundary.

22. The method of claim 20, wherein the one or more TRSs include one TRS that is configured with two power offsets to a downlink shared channel, wherein a first power offset is associated with the HD slot and a second power offset is associated with the FD slot.

23. The method of claim 20, wherein the one or more TRSs include two TRSs, wherein a first TRS of the two TRSs is associated with an HD slot type and a second TRS of the two TRSs is associated with an FD slot type.

24. A method of wireless communication performed by a user equipment (UE), comprising:
receiving, from a network node associated with a full-duplex (FD) network, an indication of an automatic gain control (AGC) symbol at a boundary between a half-duplex (HD) slot or symbol and an FD slot or symbol; and
calculating an AGC using the AGC symbol based at least in part on a switching between the HD slot or symbol and the FD slot or symbol.

25. The method of claim 24, wherein the AGC symbol is associated with a sequence or a reference signal, or wherein the AGC symbol is a duplicate of a first symbol in a slot.

26. The method of claim 24, wherein:
the indication of the AGC symbol is received via a semi-static radio resource control configuration;
the indication of the AGC symbol is received via a scheduling downlink control information; or
the indication of the AGC symbol is associated with a configuration of the AGC symbol that is received via a medium access control control element, and wherein the configuration is activated or deactivated by the network node.

27. The method of claim 24, wherein the AGC symbol is associated with an adaptation of a front-end AGC gain based at least in part on a radio frequency (RF) detection of an in-band or channel jammer due to inter-UE cross-link interference, and wherein the AGC gain is adapted based at least in part on an energy associated with a detected signal from the RF detection satisfying a threshold.

28. The method of claim 24, wherein a location of the AGC symbol in a slot is a first symbol of the slot based at least in part on a downlink shared channel or a downlink control channel being transmitted in the slot.

29. The method of claim 24, wherein a location of the AGC symbol in a slot is a location of a last symbol of a previous slot based at least in part on a downlink shared channel or a downlink control channel being transmitted in the slot.

30. The method of claim 24, wherein the AGC symbol is in a slot that indicates a synchronization signal block, a tracking reference signal, a radio link monitoring reference signal, or a radio resource monitoring reference signal and is preceded by a different type of slot, wherein the slot is the FD slot and the different type of slot is the HD slot.
